(19) United States
(12) Patent Application Publication
(10) Pub. No.: US 2005/0234189 A1
(43) Pub. Date: Oct. 20, 2005

(54) Preparation method of latex polymer comprising wax and colorant

(75) Inventors: Jun-young Lee, Seongnam-si (KR); Kyung-yol Yon, Seongnam-si (KR); Sang-woo Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/071,318

(22) Filed: Mar. 4, 2005

(30) Foreign Application Priority Data
Apr. 19, 2004 (KR) 2004-26750

(51) Int. Cl. C08K 3/00

(52) U.S. Cl. 524/800; 430/137.15

(57) ABSTRACT

A preparation method of a latex polymer that includes a wax and a colorant, includes: preparing a dispersion containing a colorant and a wax; preparing an aqueous phase containing the dispersion; preparing an organic phase containing a monomer; mixing the aqueous phase with the organic phase, and preparing a mixture; homogenizing the mixture; and adding a polymerization initiator to the mixture, and causing polymerization. Embodiments of the present invention enable preparation of a latex polymer that includes the wax and the colorant through a single process, without utilizing any aggregation therefor. Also, the aggregation between the wax, the colorant and the latex particle is optimized, and the latex has an optimized particle size distribution.

### CROSS-REFERENCE TO RELATED APPLICATIONS

This application claims the benefit under 35 U.S.C. § 119 from Korean Patent Application No. 2004-26750, filed on Apr. 19, 2004, the entire content of which is incorporated herein by reference.

### BACKGROUND OF THE INVENTION

1. Field of the Invention

The present invention relates in general to a preparation method of a latex polymer. More specifically, the present invention relates to a preparation method of a latex polymer comprising a wax and a colorant for use with ink or toner composition for an electrophotographic image forming apparatus.

2. Description of the Related Art

Electrophotographic image forming apparatuses, including fax machines, LED or LCS printers, digital printers, laser printers, or laser copiers, use a toner composition containing a colorant, a binder resin, a charge control agent, and other functional additives.

Colorants are largely divided into dye colorants and pigment colorants. The pigment colorants, compared to the dye colorants, have an excellent thermal stability and lightproofness and thus, are used more often as toner colorants.

The binder resin corresponds to about 90% of the entire toner composition, and its main function is to bind toner particles onto a recording medium. There are many types of polymers that are eligible for use as the binder resin, but a colloid gel type latex with its two components being dispersed to particles is usually used as the binder resin.

For example, a polymer resin for preparing a latex is selected from a group including poly(styrenebutadiene), poly(para-methyl styrenebutadiene), poly(meta-methyl styrenebutadiene), poly(alpha-methyl styrenebutadiene), poly(methylmethacrylate butadiene), poly(ethylmethacrylate-butadiene), poly(propylmethacrylate butadiene), poly(butylmethacrylate-butadiene), poly(methylacrylate butadiene), poly(ethylacrylate butadiene), poly(prophylacrylate butadiene), poly(butylacrylate butadiene), poly(styrene isoprene), poly(para-methyl styrene isoprene), poly(meta-methyl styrene isoprene), poly(meta-methyl styrene isoprene), poly(alpha-methyl styrene isoprene), poly(methylmethacrylate isoprene), poly(ethylmethacrylate isoprene), poly(propylacrylate isoprene), poly(butylacrylate isoprene), poly(styrene butadiene acrylic acid), poly(styrene butadiene methacrylic acid), polyethylene terephthalate, polypropylene terephthalate, polybutylene terephthalate, polypentylene terephthalate, polyhexalene terephthalate, polyheptadene terephthalate, and polyoctalene terephthalate.

The charge controller agent is employed to control the quantity of electric charge on toner particles. As for the charge controller agent, metal azo compounds, salicylic acid metal complexes, nigrosine, or quaternary ammonium salts may be used.

Among the functional additives contained in the toner is a releasing agent which gives a neat and quick release. Particularly, the releasing agent is used to more easily release a roller from a toner when a toner image is transferred onto a recording medium and thus, to prevent a toner offset. Many times, the recording medium is adhered to the roller because of the toner, so that the recording medium is easily caught in the middle. This is why the releasing agent is added to the toner composition.

A generally used releasing agent is a polyolefin group having a low molecular weight, a silicon group having a softening point by the application of heat, a fatty acid amid group, or wax.

U.S. Pat. No. 6,120,967 discloses a process for the preparation of a toner composition, including: preparing a wax emulsion, a pigment dispersion in water, and a resin latex; blending the wax emulsion, the pigment dispersion, and the resin latex; and adding a coagulant to the resulting resin-pigment blend. However, the coagulant according to this disclosure aggregates not only heterogeneous particles but also homogeneous particles, so the aggregation between heterogeneous particles is not sufficiently strong, and an excellent dispersion capability is not obtained. The use of the disclosed coagulant may have a serious effect on the physical properties of a toner that is finally produced. Moreover, in the case of adding a wax after the aggregation, only a certain type of wax having a high melting point may be used to control the shape of the particles. Thus, it becomes very difficult to prepare a low-temperature fixing toner.

U.S. Pat. No. 5,863,696 discloses a production method of a polymer having a pigment by forming a pigment dispersion, and emulsifying a polymerizable monomer in the pigment dispersion. Although the disclosure introduced a technique for polymerizing latex particles through the aggregation of a pigment and a monomer particle without help of a coagulant, a wax emulsion is additionally used as a releasing agent. However, it is not always convenient to aggregate the wax substance in the wax emulsion for use with the coagulant.

### SUMMARY OF THE INVENTION

It is, therefore, an aspect of the present invention to provide a latex polymer comprising a wax and a colorant, which is prepared by polymerization of a releasing agent, a colorant and a binder resin, whereby the aggregation between the wax and colorant and a latex particle may be improved, each latex particle has a high dispersibility, the particle size of the toner composition may be reduced, and toner fixing at a low temperature may be realized.

To achieve the above aspects and advantages, a preparation method of a latex polymer includes: preparing a dispersion containing a colorant and a wax; preparing an aqueous phase containing the dispersion; preparing an organic phase containing a monomer; mixing the aqueous phase with the organic phase, and preparing a mixture; homogenizing the mixture; and adding a polymerization initiator to the mixture to cause polymerization.

Preferably, the dispersion is prepared by dispersing in distilled water, the colorant, a dispersing agent, and a wax emulsion in which the wax is dispersed.

Preferably, the wax is selected from a group consisting of natural waxes including waxes from a plant including carnauba wax and bayberry wax, and waxes from an animal including beeswax, shellac wax, and spermaceti wax; mineral waxes including montan wax, ozokerite wax, and ceresin wax; petroleum based waxes including paraffin wax and microcrystalline wax; and synthetic waxes including Fischer-Tropsch wax, polyethylene wax, polypropylene wax, acrylate wax, fatty acid amid wax, silicon wax, and polytetrafloroethylene wax.

Preferably, the amount of the wax is within a range from 1 phr (parts per hundred resin) to 50 phr.

Preferably, the amount of the colorant is within a range from 1 phr to 20 phr.

Preferably, the latex polymer contains at least one colorant selected from a group consisting of azo pigments, phthalocyanine pigments, basic dyes, quinacridone pigments, dioxazine pigments, and diazo pigment; carbon black; and inorganic pigments comprising chromate, ferrocyanices, oxide, selenium sulfide, sulfate, silicate, carbonate, phosphate, and metal powder.

Preferably, the dispersing agent is a surfactant selected from the group of anionic surfactants consisting of sodium dodecyl sulfate, sodium dodecylbenzene sulfonate, sodium dodecylnaphthalene, dialkyl benzenealkyl, sulfate, and sulfonate; cationic surfactants comprised of dialkyl benzenealkyl ammonium chloride, alkyl benzyl methyl ammonium chloride, alkyl benzyl dimethyl ammonium bromide, benzalconium chloride, cetyl pyridium bromide, dodecylbenzyl triethyl ammonium chloride, lauryl amine acetate, stearyl amine acetate, and lauryl trimethyl ammonium chloride; anionic/cationic surfactants comprised of lauryl dimethylamineoxide; and non-ionic surfactants consisting of polyvinyl alcohol, polyacrylic acid, metalose, methyl cellulose, ethyl cellulose, propyl cellulose, hydroxyethyl cellulose, carboxymethyl cellulose, tristyrylphenol ethoxylate phosphate ester, polyoxyethylenecetyl ether, polyoxyethylene lauryl ether, octyl polyoxyethyiene ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol.

Preferably, the latex polymer comprises at least one monomer selected from the group consisting of styrene monomers comprising styrene, methylstyrene, chlorostyrene, dichlorostyrene, p-terr-butylstyrene, p-n-butylstyrene, and p-n-nonylstyrene; (metha)acrylic acid ester monomers comprising acrylate, methyl acrylate, ethyl acrylate, propyl acrylate, isobutyl acrylate, n-butyl acrylate, beta carboxy ethyl acrylate, hydroxyethyl acrylate, ethylhexyl acrylate, methacrylate, methyl methacrylate, ethyl methacrylate, propyl methacrylate, n-butyl methacrylate, isobutyl methacrylate, hydroxyethyl methacrylate, and ethylhexyl methacrylate; carboxyl group-containing monomers consisting of acrylic acid, itaconic acid, methacrylic acid, maleic acid, fumaric acid, and cinnamic acid; sulfonic acid containing monomers comprising styrene sulfonate; amino styrene and quaternary ammonium salt thereof; monomers with a nitrogen containing hetero ring, consisting of vinylpyridine, and vinylpyrolidone; acrylonitryl, butadiene, isoprene, and divinylbenzene.

Preferably, the mixture is heated after it is homogenized.

Preferably, the polymerization initiator is selected from the group consisting of potassium persulfate, ammonium persulfate, benzoyl peroxide, lauryl peroxide, sodium persulfate, hydrogen peroxide, t-butyl hydroperoxide, cumene hydroperoxide, para-mentane peroxide, and peroxy carbonate.

Preferably, the amount of the polymerization initiator is within a range from 1 phr to 5 phr.

Preferably, a particle size of the latex polymer is within a range from 0.1 μm to 3 μm.

Preferably, a glass transition temperature of the latex polymer particle is within a range from 40° C. to 100° C., and a melting point of the latex polymer particle is within a range from 50° C. to 150° C.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a toner particle prepared by using a related art method;

FIG. 2 is a schematic diagram of a toner particle comprising a latex polymer according to a preferred embodiment of the present invention; and

FIG. 3 is a flow chart illustrating operations of a preparation method of a latex polymer in accordance with an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The matters defined in the description such as a detailed construction and elements are only provided to assist in a comprehensive understanding of the invention. Thus, it is apparent that the present invention may be carried out without those defined matters. Also, well-known functions or constructions are not described in detail since they would obscure the invention in unnecessary detail.

A latex polymer among the toner composition may be used as a binder. Particularly, a latex polymer according to and embodiment of the present invention includes wax and a colorant and thus, functions as a releasing agent and colorant at the same time. Besides the toner composition, the latex polymer of the invention may be used with an ink composition having a releasing agent, a colorant, and a binder.

In general, ‘latex’ means a natural or synthetic two-component micropolymer, with less than about 1 μm in size, dispersed in a solvent. To prepare the latex polymer, a monomer, a surfactant, and an initiator are blended and are subjected to emulsion polymerization. Emulsion polymerization is a type of polymerization that takes place in an emulsion typically incorporating monomer (or polymer), surfactant, and water; or when surfactants reach the critical micelle concentration, colloid micelles (tiny particles) are created. In a water continuous phase, the initiator is radicalized, and this radicalized initiator reacts with the monomer in the micelle and is encapsulated in the micelle.

To prepare the latex polymer having wax and a colorant, a dispersion having a colorant and wax needs to be first prepared.

Wax in an embodiment of the present invention refers to a natural or synthetic material that is dispersant, hard or fragile, self-assembled or micro crystalline, translucent or transparent at 20° C.; melts without decomposition at temperatures higher than 40° C., has a relatively low viscosity, is nonviscous, and maintains high temperature-dependent homeostasis and solubility at temperatures slightly higher than its melting point.

In effect, any commercialized waxes may be used for the preparation of the dispersion of the present invention. Examples of the wax for use in the preparation of the dispersion include natural waxes including waxes from a plant, e.g., carnauba wax and bayberry wax, and waxes from an animal, e.g., beeswax, shellac wax, and spermaceti wax; mineral waxes including montan wax, ozokerite wax, and ceresin wax; petroleum based waxes including paraffin wax and microcrystalline wax; and synthetic waxes including Fischer-Tropsch wax, polyethylene wax, polypropylene wax, acrylate wax, fatty acid amid wax, silicon wax, and polytetrafluoroethylene wax, or mixtures thereof, and the examples here are for illustrative purposes only.

As for the colorant for use in the preparation of the dispersion, well-known or common colorants may be utilized. Examples of the colorants include organic pigments including azo pigments, phthalocyanine pigments, basic dyes, quinacridone pigments, dioxazine pigments, and diazo pigment; carbon black; inorganic pigments including chromate, ferrocyanices, oxide, selenium sulfide, sulfate, silicate, carbonate, phosphate, and metal powder, or mixtures thereof, and the examples here are for illustrative purposes only. In consideration of the environment factor, it is preferable to use organic pigments, and carbon black as a black pigment.

Examples of organic pigments for use in embodiments of the present invention are as follows:
Blue and/or green pigments: copper phthalocyanine, C.I.P.B. (C.I. Pigment Blue) 15, 15:1, 15:2, 15:3, 15:4, 15:6, 16 (metal-free phthalocyanine) or aluminum phthalocyanine, nickel phthalocyanine, vanadium phthalocyanine, and bridged phthalocyanine dimer/oligomer (e.g., Si-bridged phthalocyanine);
Orange pigments: P.O.5, 36,34,13, 43, 62,71, and 72;
Yellow pigments: RY.12, 13,17, 74, 83, 93, 122, 146, 155, 180, 174, and 185;
Red pigments: P.R.48, 57, 122, 146, 147, 176, 184, 186, 202, 207, 238, 254, 255, 269, 270, and 272;
Violet pigments: P.V.1, 19, and 23; and
Pigment mixture: P.V.19/P.R.122 or P.R.146/147.

Both wax and colorant are components that blend into the latex particles. Since it is important to obtain a uniform mixture, the contents (or amounts) of the wax and the colorant should be uniform in the dispersion also.

Preferably, the amount of wax is in a range from 1 phr to 50 phr. If the amount of wax is less than 1 phr, the wax cannot accomplish its performance as a releasing agent; if the amount of wax is greater than 50 phr, the amount of resin included in a latex particle becomes relatively low, which decreases the performance of the latex as a binder.

The amount of the colorant is preferably in a range from 1 phr to 20 phr. If the amount of the colorant is less than 1 phr, the latex particle will not show very much color; if the amount of the colorant is greater than 20 phr, the amount of the resin included in a latex particle becomes relatively low, which decreases the performance of the latex as a binder.

Here, as noted above, the term ‘phr’ is an abbreviation for ‘parts per hundred of resin’, and refers to a mass unit of an object additive per hundred parts of resin.

To prepare the dispersion, a wax emulsion is first prepared. Then, wax emulsion, colorant, and dispersing agent are put in distilled water, and are dispersed therein with help of a milling machine.

Although one of water-soluble polymers, surfactants, and inorganic compounds may be used as the dispersing agent, surfactants are most frequently used. Examples of the surfactants suitable for the dispersing agent of embodiments of the present invention include anionic surfactants including sodium dodecyl sulfate, sodium dodecylbenzene sulfonate, sodium dodecylnaphthalene sulfate, dialkyl benzenealkyl sulfate, and sulfonate; cationic surfactants including dialkyl benzenealkyl ammonium chloride, alkyl benzyl methyl ammonium chloride, alkyl benzyl dimethyl ammonium bromide, benzalconium chloride, cetyl pyridium bromide, dodecylbenzyl triethyl ammonium chloride, lauryl amine acetate, stearyl amine acetate, and lauryl trimethyl ammonium chloride; anionic/cationic surfactants including lauryl dimethylamineoxide; and non-ionic surfactants including polyvinyl alcohol, polyacrylic acid, metalose, methyl cellulose, ethyl cellulose, propyl cellulose, hydroxyethyl cellulose, carboxymethyl cellulose, tristyrylphenol ethoxylate phosphate ester, polyoxyethylenecetyl ether, polyoxyethylene lauryl ether, octyl polyoxyethylene ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, or mixtures thereof, and the examples here are for illustrative purposes only.

Examples of surfactants that are commercially used now include DOWFAX produced by DOW CHEMICAL COMPANY, TERGITOL, and TRITON.

As for the milling machine, a ball mill, a dino mill, an EIGER mill 250, or a DISPERMAT may be used. Thus, the dispersion and glass beads are milled together at 2000 rpm to 10000 rpm for about 1 hour to 5 hours.

Preferably, deionized water is used for the preparation of the dispersion of the invention. The deionized water is prepared by bubbling water with nitrogen gas, and deoxidizing the water.

Meanwhile, a dispersing agent is dissolved in distilled water by heating, and the resulting solution is blended with the dispersion that is prepared to obtain an aqueous phase. Again, it is desirable to use deionized water as the solvent for the dispersing agent. Also, the above-described surfactant may be used as the dispersing agent.

Apart from the preparation of the dispersion, an organic phase containing a monomer is prepared. Examples of the monomer include styrene monomers including styrene, methylstyrene, chlorostyrene, dichlorostyrene, p-terr-butylstyrene, p-n-butylstyrene, and p-n-nonylstyrene; (meth)acrylic acid ester monomers including acrylate, methyl acrylate, ethyl acrylate, propyl acrylate, isobutyl acrylate, n-butyl acrylate, beta carboxy ethyl acrylate, hydroxyethyl acrylate, ethylhexyl acrylate, methacrylate, methyl methacrylate, ethyl methacrylate, propyl methacrylate, n-butyl methacrylate, isobutyl methacrylate, hydroxyethyl methacrylate, and ethylhexyl methacrylate; carboxyl group-containing monomers including acrylic acid, itaconic acid, methacrylic acid, maleic acid, fumaric acid, and cinnamic acid; sulfonic acid containing monomers including styrene sulfonate; amino styrene and quaternary ammonium salt thereof; monomers with a nitrogen containing hetero ring, which include vinylpyridine, and vinylpyrolidone; acrylonitryl, butadiene, isophrene, and divinylbenzene, or mixtures thereof, and these examples are for illustrative purposes only.

Thusly prepared aqueous phase and organic phase are mixed in a reaction vessel. Then, the resulting mixed solution is homogenized with help of a homogenizer. As for the homogenizer, a homomixer, a pressure kneader/cotter, an extruder and media distributor, a ball mill having media, a sand mill, or a dino mill may be utilized. The homogenization process is carried out at 1000 rpm to 7000 rpm for about 1 min-60 min.

Then, the homogenous mixed solution is poured into a reaction vessel and is stirred at a stirrer speed ranging from 100 rpm to 800 rpm, and heated at 50° C. to 80° C. while stirred. The temperature of the mixed solution is not homogeneous, a polymerization initiator is added, and the reaction vessel was purged with nitrogen gas to cause substantial polymerization of the mixture. The mixed solution is subjected to the polymerization reaction for 5 to 24 hours, and is cooled at room temperature.

The polymerization initiators are largely divided into water soluble initiators and oil soluble initiators. Even though it is not an absolute requirement for embodiments of the present invention, water soluble initiators are more preferably used. Examples of the water soluble polymerization initiator include potassium persulfate, ammonium persulfate, benzoyl peroxide, lauryl peroxide, sodium persulfate, hydrogen peroxide, t-butyl hydroperoxide, cumene hydroperoxide, para-mentane peroxide, peroxy carbonate, or mixtures thereof, and the examples here are for illustrative purposes only.

The amount of the polymerization initiator is preferably in a range of 1 phr to 5 phr, which is determined according to the amounts of other additives participating in the polymerization reaction.

According to the traditional polymerization mechanism, a radicalized initiator reacts with a monomer in the micelle and thus, is encapsulated in the micelle (i.e., micelle nucleation). However, in the present invention, a polymerization nucleation site is created in a dispersion droplet having wax and colorant, so the encapsulation of the wax and the colorant in a final latex particle is enabled. Therefore, unlike the related art process, embodiments of the present invention do not require an additional coagulant because the aggregation between the wax, the colorant and the latex is sufficiently strong, and particularly, embodiments of the present invention enable preparing a latex polymer having a much improved particle size distribution.

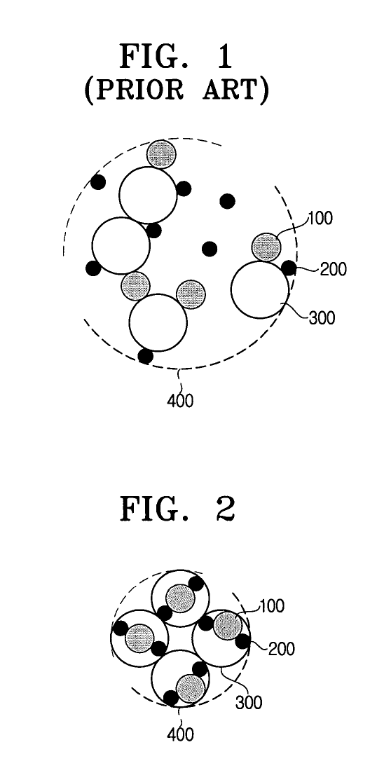

FIG. 1 is a schematic diagram of a toner particle prepared by using a related art method; and FIG. 2 is a schematic diagram of a toner particle comprising a latex polymer according to a preferred embodiment of the present invention. Like elements in the drawings are indicated by like reference numerals.

Referring to FIG. 1, the toner particle 400 is composed of waxes 100, colorants 200, and latex particles 300 that bind the waxes 100 and the colorants 200. However, their cohesion is not strong enough, and the toner particle 400 is relatively large, having much space unoccupied.

Referring now to FIG. 2, the waxes 100 and the colorants 200 are encapsulated in the latex particles 300 and thus, their cohesion is very high, and the size of the latex particle 400 is relatively small. In addition, the final latex particles 300 have a uniform size, and each particle has the same properties because both the waxes 100 and the colorants 200 are encapsulated in the particles 300 through the emulsion polymerization.

The present invention will be now explained in more detail with respect to Examples below.

### EXAMPLE 1

Preparation of Dispersion

100 g of Carnauba/polyethylene mixture wax emulsion (150 nm), 30 g of a colorant (P.B. 15:3), 100 g of deionized water and 10 g of a surfactant (DOWFAX) were blended and milled at 3000 rpm for 3 hours with the aid of 200 g of glass beads and a DISPERMAT to obtain a wax/colorant dispersion.

Preparation of Aqueous Phase

10 g of dispersion being prepared, 200 g of deionized water, 3 g of DOWFAX, and 3 g of tristyryl phenol ethoxylate phosphate ester were blended to prepare an aqueous phase.

Preparation of Organic Phase

Styrene, butyl acrylate, and acrylic acid were mixed in a ratio of 7:2:1 to prepare 100 g of an organic phase.

Preparation of Latex

The thusly prepared aqueous phase and the organic phase were mixed in a 1 L reaction vessel (e.g., a glass beaker), and were homogenized at 7000 rpm for 30 minutes with help of I KA ULTRA TURREX. Next, the resulting mixture was put in another reaction vessel, and was stirred at 100 rpm and heated to approximately 75° C. When the internal temperature of the reaction vessel reached 75° C., 2 wt. % of ammonium persulfate was added, and the reaction vessel was purged with nitrogen gas. Then, the mixed solution was allowed to stand at approximately 75° C. for the reaction for approximately 24 hours.

When the reaction was complete, the mixed solution was cooled at room temperature.

Then, the latex particle was submitted to an analysis with the aid of a DSC (Differential Scanning Calorimeter). According to the analysis result, the glass transition temperature and the melting point coexist, in which the glass transition temperature is 69° C., and the melting point is 85° C. Also, the volume average size of the final latex particle including wax and colorant was 270 nm and number average size thereof was 230 nm.

### EXAMPLE 2

The latex was prepared as described in the method of Example 1, except that 80 g of polyethylene wax emulsion was used instead of 100 g of Carnauba/polyethylene mixture wax emulsion.

Then, the latex particle was submitted to an analysis with the aid of a DSC (Differential Scanning Calorimeter). According to the analysis result, the glass transition temperature and the melting point coexist, in which the glass transition temperature was 69° C., and the melting point was 110° C. Also, the volume average size of the final latex particle including wax and colorant was 162 nm and number average size thereof was 122 nm.

### EXAMPLE 3

The latex was prepared as described in the method of Example 1, except that 90 g of Carnauba wax emulsion was used instead of 100 g of Carnauba/polyethylene mixture wax emulsion.

Then, the latex particle was submitted to an analysis with the aid of a DSC (Differential Scanning Calorimeter). According to the analysis result, the glass transition temperature and the melting point coexist, in which the glass transition temperature was 69° C., and the melting point was 85° C. Also, the volume average size of the final latex particle including wax and colorant was 300 nm and number average size was 140 nm.

### EXAMPLE 4

The latex was prepared as described in the method of Example 1 except that 120 g of paraffin wax emulsion was used instead of 100 g of Carnauba/polyethylene mixture wax emulsion.

Then, the latex particle was submitted to an analysis with the aid of a DSC (Differential Scanning Calorimeter). According to the analysis result, the glass transition temperature and the melting point coexist, in which the glass transition temperature was 69° C., and the melting point was 60° C. Also, the volume average size of the final latex particle including wax and colorant was 190 nm and number average size thereof was 144 nm.

### EXAMPLE 5

The latex was prepared as described in the method of Example 1, except that P.Y.180 instead of P.B. 15:3 was used as a colorant.

Then, the latex particle was submitted to an analysis with the aid of a DSC (Differential Scanning Calorimeter). According to the analysis result, the glass transition temperature and the melting point coexist, in which the glass transition temperature was 69° C., and the melting point was 85° C. Also, the volume average size of the final latex particle including wax and colorant was 270 nm and number average size thereof was 230 nm.

### EXAMPLE 6

The latex was prepared as described in the method of Example 1, except that P.R.122 instead of P.B. 15:3 was used as a colorant.

Then, the latex particle was submitted to an analysis with the aid of a DSC (Differential Scanning Calorimeter). According to the analysis result, the glass transition temperature and the melting point coexist, in which the glass transition temperature was 69° C., and the melting point was 85° C. Also, the volume average size of the final latex particle including wax and colorant was 591 nm and number average size thereof was 310 nm.

### EXAMPLE 7

The latex was prepared as described in the method of Example 1, except that carbon black (NIPEX 70) instead of RB. 15:3 was used as a colorant.

Then, the latex particle was submitted to an analysis with the aid of a DSC (Differential Scanning Calorimeter). According to the analysis result, the glass transition temperature and the melting point coexist, in which the glass transition temperature was 69° C., and the melting point was 85° C. Also, the volume average size of the final latex particle including wax and colorant was 150 nm and number average size thereof was 101 nm.

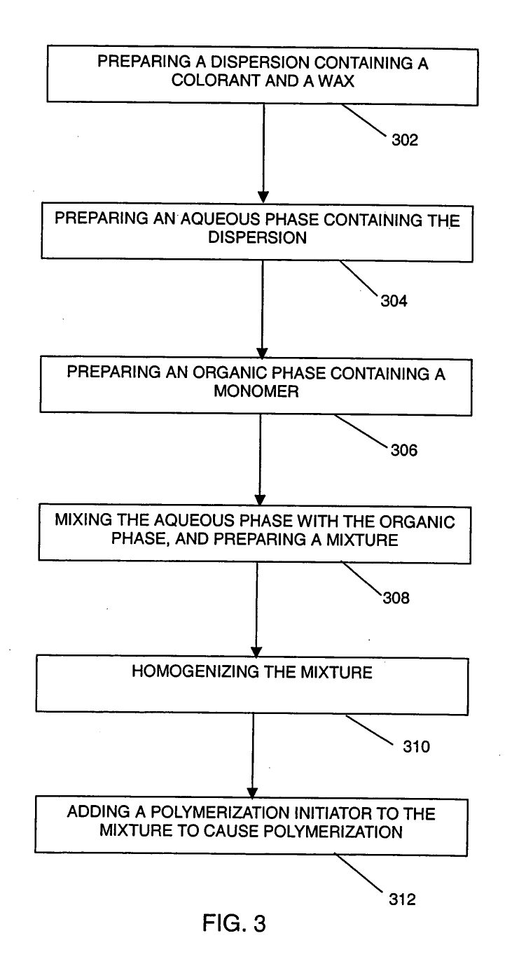

Thus, as illustrated in FIG. 3, a flow chart illustrating operations of a preparation method of a latex polymer in accordance with an embodiment of the present invention, the method comprises: preparing a dispersion containing a colorant and a wax 302; preparing an aqueous phase containing the dispersion 304; preparing an organic phase containing a monomer 306; mixing the aqueous phase with the organic phase, and preparing a mixture 308; homogenizing the mixture 310; and adding a polymerization initiator to the mixture to cause polymerization 312.

As illustrated in FIG. 4, a flow chart illustrating operations of a preparation method of a latex polymer in accordance with another embodiment of the present invention, the method comprising: preparing an aqueous dispersion containing a colorant, a wax emulsion, and a first surfactant 402; preparing an aqueous phase containing the aqueous dispersion, the first surfactant and a second surfactant 404; preparing an organic phase containing a monomer 406; mixing the aqueous phase with the organic phase, and preparing a mixture 408; homogenizing the mixture 410; and adding a polymerization initiator to the mixture to cause polymerization 412, wherein the polymerization process includes stirring, heating to approximately 75° C., adding the polymerization initiator, purging the reaction vessel with nitrogen gas, allowing the mixture to polymerize at approximately 75° C. for a predetermined period of time, then cooling to room temperature.

In conclusion, the present invention provides a simplified preparation method of latex polymers containing the waxes and colorants, in which the cohesion between the wax, the colorant and the latex particle is much improved, without the aid of a coagulant. In addition, the latex may have a much improved particle size distribution due to containing the waxes and colorants. Since the wax is encapsulated in the latex particle, the melting point of the wax may be relatively low and thus, enables preparation of a low-temperature fixing toner.

Although a few embodiments of the present invention have been shown and described, it would be appreciated by those skilled in the art that changes may be made in these embodiments without departing from the principles and spirit of the invention, the scope of which is defined in the claims and their equivalents.

1. A preparation method of a latex polymer, the method comprising:
preparing a dispersion containing a colorant and a wax;
preparing an aqueous phase containing the dispersion;
preparing an organic phase containing a monomer;
mixing the aqueous phase with the organic phase, and preparing a mixture;
homogenizing the mixture; and
adding a polymerization initiator to the mixture to cause polymerization.

2. The method according to claim 1, wherein the dispersion is prepared by dispersing in distilled water a wax emulsion in which the wax is dispersed, the colorant, and a dispersing agent.

3. The method according to claim 1, wherein the wax is selected from the group consisting of natural waxes including waxes from a plant, waxes from an animal, mineral waxes, petroleum based waxes, and synthetic waxes.

4. The method according to claim 1, wherein the amount of the wax is within a range from 1 phr to 50 phr.

5. The method according to claim 1, wherein the amount of the colorant is within a range from 1 phr to 20 phr.

6. The method according to claim 1, wherein the latex polymer contains at least one colorant selected from the group consisting of azo pigments, phthalocyanine pigments, basic dyes, quinacridone pigments, dioxazine pigments, and diazo pigment; carbon black; and inorganic pigments comprising chromate, ferrocyanices, oxide, selenium sulfide, sulfate, silicate, carbonate, phosphate, and metal powder.

7. The method according to claim 2, wherein the dispersing agent is selected from the group consisting of anionic surfactants consisting of sodium dodecyl sulfate, sodium dodecylbenzene sulfonate, sodium dodecylnaphthalene, dialkyl benzenealkyl, sulfate, and sulfonate; cationic surfactants comprised of dialkyl benzenealkyl ammonium chloride, alkyl benzyl methyl ammonium chloride, alkyl benzyl dimethyl ammonium bromide, benzalconium chloride, cetyl pyridium bromide, dodecylbenzyl triethyl ammonium chloride, lauryl amine acetate, stearyl amine acetate, and lauryl trimethyl ammonium chloride; anionic/cationic surfactants consisting of lauryl dimethylamineoxide; and non-ionic surfactants consisting of polyvinyl alcohol, polyacrylic acid, metalose, methyl cellulose, ethyl cellulose, propyl cellulose, hydroxyethyl cellulose, carboxymethyl cellulose, tristyrylphenol ethoxylate phosphate ester, polyoxyethylenecetyl ether, polyoxyethylene lauryl ether, octyl polyoxyethylene ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol.

8. The method according to claim 1, wherein the latex polymer comprises at least one monomer selected from the group consisting of styrene monomers consisting of styrene, methylstyrene, chlorostyrene, dichlorostyrene, p-terr-butylstyrene, p-n-butylstyrene, and p-n-nonylstyrene; (meth)acrylic acid ester monomers consisting of acrylate, methyl acrylate, ethyl acrylate, propyl acrylate, isobutyl acrylate, n-butyl acrylate, beta carboxy ethyl acrylate, hydroxyethyl acrylate, ethylhexyl acrylate, methacrylate, methyl methacrylate, ethyl methacrylate, propyl methacrylate, n-butyl methacrylate, isobutyl methacrylate, hydroxyethyl methacrylate, and ethylhexyl methacrylate; carboxyl group-containing monomers consisting of acrylic acid, itaconic acid, methacrylic acid, maleic acid, fumaric acid, and cinnamic acid; sulfonic acid containing monomers comprising styrene sulfonate; amino styrene and quaternary ammonium salt thereof; monomers with a nitrogen containing hetero ring, consisting of vinylpyridine, and vinylpyrolidone; acrylonitryl, butadiene, isophrene, and divinylbenzene.

9. The method according to claim 1, further comprising:
heating the homogenized mixture.

10. The method according to claim 1, wherein the polymerization initiator is selected from the group consisting of potassium persulfate, ammonium persulfate, benzoyl peroxide, lauryl peroxide, sodium persulfate, hydrogen peroxide, t-butyl hydroperoxide, cumene hydroperoxide, para-mentane peroxide, and peroxy carbonate.

11. The method according to claim 1, wherein the amount of the polymerization initiator is within a range from 1 phr to 5 phr.

12. The method according to claim 1, wherein a particle size of the latex polymer is within a range from 0.1 μm to 3 μm.

13. The method according to claim 1, wherein a glass transition temperature of the latex polymer particle is within a range from 40° C. to 100° C., and a melting point of the latex polymer particle is within a range from 50° C. to 150° C.

14. The method according to claim 3, wherein the wax is selected from the group consisting of carnauba wax, bayberry wax, beeswax, shellac wax, spermaceti wax, montan wax, ozokerite wax, ceresin wax, paraffin wax, microcrystalline wax, Fischer-Tropsch wax, polyethylene wax, polypropylene wax, acrylate wax, fatty acid amid wax, silicon wax, and polytetrafluoroethylene wax.
